(19) United States
(12) Patent Application Publication
(10) Pub. No.: US 2015/0293526 A1
(43) Pub. Date: Oct. 15, 2015

(54) Substrate Treating Apparatus, Substrate Treating Method, and Recording Medium

(71) Applicant: PSK Inc., Gyeonggi-do (KR)

(72) Inventor: Wook Lee, Gyeonggi-do (KR)

(21) Appl. No.: 14/560,028

(22) Filed: Dec. 4, 2014

(30) Foreign Application Priority Data
Apr. 10, 2014 (KR) 10-2014-0043017

(51) Int. Cl. G05B 19/418

(52) U.S. Cl. CPC G05B 19/418; G05B 2219/45031

(57) ABSTRACT

Provided is a substrate treating apparatus. The substrate treating apparatus includes a module controller receiving the data measured by a sensing unit, an equipment control unit receiving the data from the module controller, and a processing unit receiving the data from the equipment control unit and processing the data, wherein the processing unit calculates latency by using a first time, which is a time when the module controller receives the data from the sensor unit, and a second time, which is a time when the equipment control unit transmits the data to the processing unit.

### CROSS-REFERENCE TO RELATED APPLICATIONS

This U.S. non-provisional patent application claims priority under 35 U.S.C. §119 of Korean Patent Application No. 10-2014-0043017, filed on Apr. 10, 2014, the entire contents of which are hereby incorporated by reference.

### BACKGROUND OF THE INVENTION

The present invention disclosed herein relates to a substrate treating apparatus, a substrate treating method using the same and a recording medium.

In order to treat a process of manufacturing a semiconductor device, typical semiconductor manufacturing equipment includes a plurality of process modules treating the corresponding process and at least one transfer module transferring a semiconductor substrate to the plurality of process modules. Such semiconductor manufacturing equipment monitors, in real time, an operation state of each module for improving work efficiency and preventing process hazards in advance at the time of process treating. To this end, a controller controlling a transfer module and a process module includes, for example, a transfer module controller controlling at least one transfer module and a process module controller controlling a plurality of process modules. In addition, each controller is electrically connected to a sensor unit included in the transfer module and the process module, measures in real time a process parameter, which is a measurement target, and provides data to an equipment control unit for controlling general operation of a semiconductor manufacturing equipment. FIG. 1 illustrates that management software data-processes pressure values measured by a sensor unit. At this point, a worker checks data through management software and controls process conditions or a process time. However, latency occurs in real-time data, which is any digital or analog information to be processed or transmitted within a predetermined time after the data is created.

### SUMMARY OF THE INVENTION

The present invention disclosed herein relates to a substrate treating apparatus capable of measuring latency.

Objects of the present invention are not limited to those described above and other objects will be clearly understood by those skilled in the art from the following description and the accompanied drawings.

Embodiments of the present invention provide substrate treating apparatuses.

The substrate treating apparatus includes a module controller receiving the data measured by a sensing unit; an equipment control unit receiving the data from the module controller; and a processing unit receiving the data from the equipment control unit and processing the data, wherein the processing unit calculates latency by using a first time, which is a time when the module controller receives the data from the sensor unit, and a second time, which is a time when the equipment control unit transmits the data to the processing unit.

In some embodiments, the processing unit may calculate the latency by using a difference between the second and first times.

In other embodiments, the sensor unit may measure the data of the process parameter plural number of times, and the processing unit may calculate the latency by calculating an average value of a plurality of differences between the second and first times.

In still other embodiments, the sensor unit may measure the data of the process parameter for a first set time and the processing unit may calculate the latency by calculating an average value of differences between the second and first times for the first set time.

In even other embodiments, the module controller may be a process module controller.

In yet other embodiments, the module controller is a transfer module controller.

In further embodiments, the process parameter may be pressure.

In still further embodiments, the process parameter may be a temperature.

In even further embodiments, the module controller may be provided in plurality.

In other embodiments of the present invention, substrate treating methods are provided.

In some embodiments, the substrate treating method in which a process parameter is measured by a sensor unit from a process module and latency is calculated by using data of the measured process parameter, wherein the processing unit calculates a first time, which is a time when a module controller receives the data from the sensor unit, and a second time, which is a time when the module controller transmits the data to an equipment control unit.

In other embodiments, the processing unit may calculate the latency by using a difference between the second and first times.

In still other embodiments, the sensor unit may measure the data of the process parameter plural number of times, and the processing unit may calculate the latency by calculating an average value of a plurality of differences between the second and first times

In even other embodiments, the sensor unit may measure the data of the process parameter for a first set time, and the processing unit may calculate the latency by calculating an average value of differences between the second and first times for the first set time.

In yet other embodiments, the module controller may be a process module controller.

In further embodiments, the module controller may be a transfer module controller.

In still further embodiments, the process parameter may be pressure.

In even further embodiments, the process parameter may be a temperature.

In yet further embodiments, the module controller may be provided in plurality.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 illustrates that management software data-processes pressure values measured by a sensor unit;

FIG. 2 is a plan view briefly illustrating a substrate treating equipment according to an embodiment of the present invention;

FIG. 3 is a block diagram illustrating a configuration of a substrate treating apparatus according to the present invention;

FIG. 4 illustrates a procedure that the substrate treating apparatus of FIG. 3 calculates latency;

FIG. 5 illustrates a difference between second and first times according to the number of times of data measurement;

FIG. 6 is a view that the difference between the second and first times is re-measured after the substrate treating apparatus is optimized;

FIG. 7 illustrates a substrate treating apparatus according to another embodiment; and

FIG. 8 illustrates a substrate treating apparatus according to another embodiment.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

The terminology used herein and the accompanied drawings are for the purpose of describing particular embodiments only and is not intended to be limiting of the invention.

In describing the present invention, a detailed description of known functions and configurations will be omitted when it may obscure the subject matter of the present invention.

Hereinafter, it will be described about an exemplary embodiment of the present invention in conjunction with the accompanying drawings.

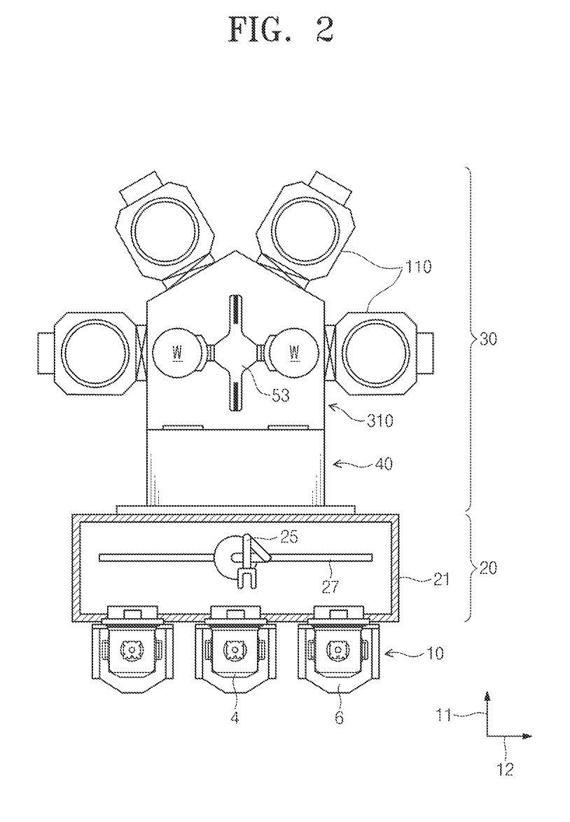

FIG. 2 is a plan view briefly illustrating a substrate treating equipment 1 according to an embodiment of the present invention.

Referring to FIG. 2, the substrate treating equipment 1 has an equipment front end module (EFEM) 20 and a process treating unit 30. The EFEM 20 and the process treating unit 30 are disposed in one direction. Hereinafter, a direction in which the EFEM 20 and the process treating unit 30 are disposed is defined as a first direction X and a direction perpendicular to the first direction X when seen from above is defined as a second direction Y.

The EFEM 20 includes a load port 10 and a transfer frame 21. The load port 10 is disposed forward of the EFEM 20 in the first direction 11. The load port 10 includes a plurality of supporting units 6. Each of the plurality of support units 6 is disposed in a row in the second direction Y and has a carrier 4 (e.g., a cassette, a FOUP, and the like) seated therein. The carrier 4 receives substrate W to be provided to the process and the substrate W that the process treating is completed. The transfer frame 21 is disposed between the load port 10 and a process processing room 30. The transfer frame 21 includes a first transfer robot 25 disposed therein and transferring the substrate W between the load port 10 and the process treating unit 30.

The first transfer robot 25 moves along a transfer rail 27 prepared in the second direction Y and transfers the substrate W between the carrier 4 and the process treating room 30.

The process treating room 30 includes a load lock chamber 40, a transfer module 50, and a process module 110.

The load lock chamber 40 is disposed adjacent to the transfer frame 21. As an example, the load lock chamber 40 may be disposed between the transfer module 310 and the EFEM 20. The load lock chamber 40 provides a waiting space before the substrate W to be provided to the process is transferred to the process module 110 or before the substrate W that the process processing is completed is transferred to the EFEM 20.

The transfer module 310 is disposed adjacent to the load lock chamber 40. The transfer module 310 has a polygonal body when seen from above. Referring to FIG. 2, the transfer module 310 has a polygonal body when seen from above. The load lock chamber 40 and a plurality of process modules 110 are disposed along a perimeter of the body of the transfer module 310 at the outside of the body. A path (not shown) through which the substrate W passes is formed in each side wall of the body, and the path connects the transfer module 310 and the load lock chamber 40 or the process modules 110. A door (not shown) is provided which opens and closes a path and encloses the inside in each path. A second transfer robot 53 is disposed inside the transfer module 310 and transfers the substrate W between the load lock chamber 40 and the process modules 110.

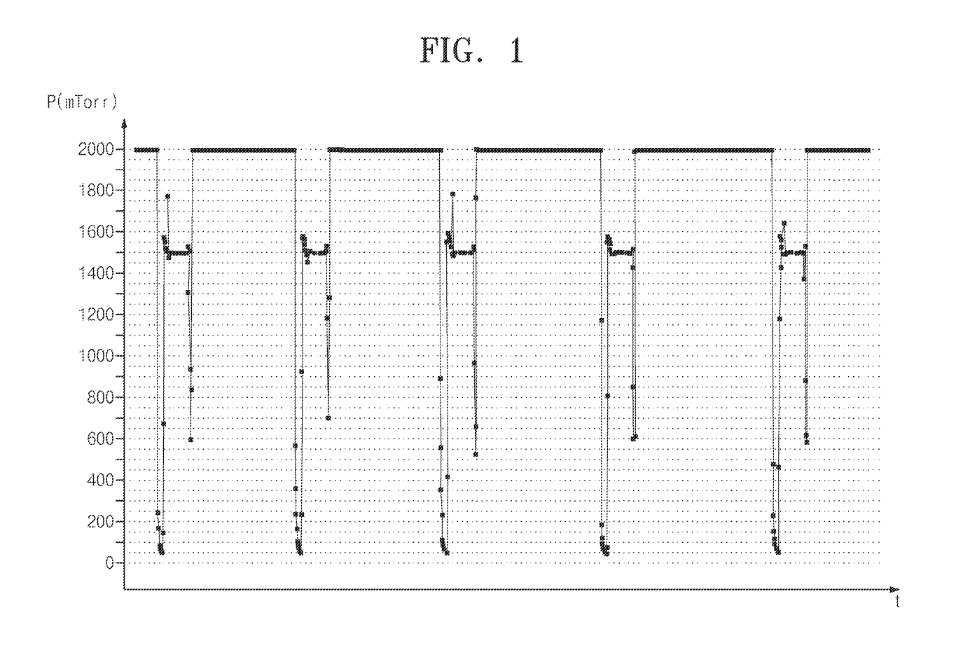

The second transfer robot 53 transfers the substrate S waiting in the load lock chamber 40 and not yet processed to the process module 110, or transfers the substrate W that the process treating is completed to the load lock chamber 40. In addition, in order to sequentially provide the substrates W to a plurality of process modules 110, the second transfer robot 53 transfers the substrates W between the process modules 110. As in FIG. 1, when the transfer module 310 has a polygonal body, each of the load lock chambers 310 is disposed on a side wall adjacent to the EFEM 20, and the process modules 110 are consecutively disposed on other side walls. The transfer module 310 may be provided in various shapes according to a required process module as well as the above described shape.

The process modules 110 are disposed along a perimeter of the transfer module 310. The process modules 110 may be provided in plurality. Process treating proceeds for the substrate W in each of the process modules 110. The process module 110 receives the substrate W from the second transfer robot 53 and performs process treating, and provides the substrate W that the process treating is completed to the second transfer robot 53. The process treating performed in each of the process modules 110 may be different from each other. The process module 110 may include a sensor unit 112 and a controller 114. At this time, the sensor unit 112 is installed in the process module 110, measures a process parameter, and controls data of the process parameter measured by the sensor unit 112.

Hereinafter, description is provided in detail about the substrate treating apparatus 100 performing a plasma process among the process modules 110.

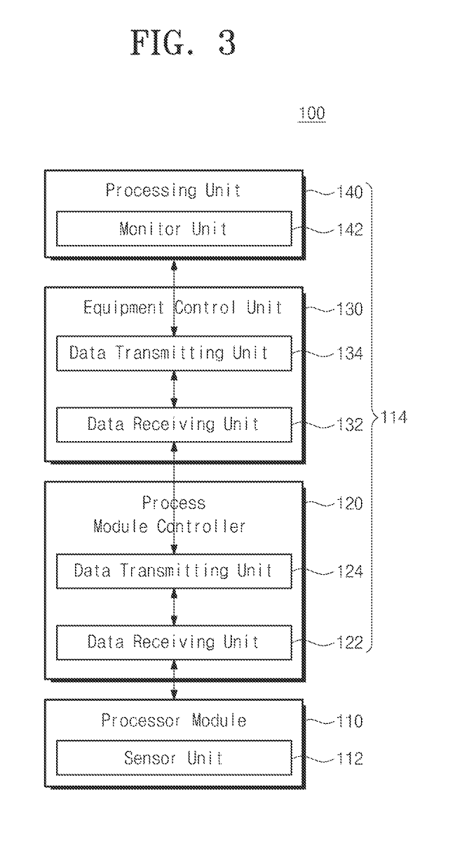

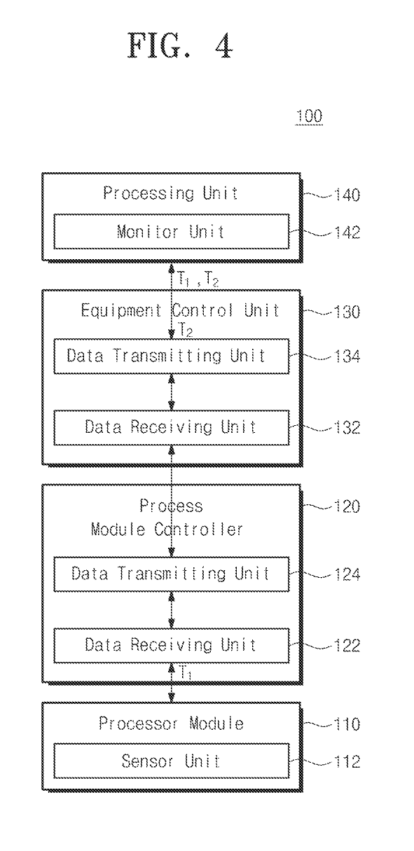

FIG. 3 is a block diagram illustrating a configuration of a substrate treating apparatus according to the present invention. FIG. 4 illustrates a procedure that the substrate treating apparatus of FIG. 3 calculates latency. Hereinafter, description is provided about a method of calculating latency by the substrate treating apparatus 100 with reference to FIGS. 3 and 4.

The substrate treating apparatus 100 includes a sensor unit 112 and a controller 114, as the process module 110. The process module 110 provides an internal space at which the substrate is processed. The sensor 112 is installed in the process module 110. The sensor unit 112 measures a process parameter in the process module 110. The controller 114 controls data of the process parameter measured by the sensor unit 112. The controller 114 includes a module controller 120, an equipment control unit 130, and a processing unit 140. The module controller 120 controls a corresponding module 110.

Hereinafter, the module controller 120 is described as a process module controller 120. The process module 110 may be provided in plurality. The process module 110 may process baking, coating, and developing processes for the substrate W. When the process module 110 is provided in plurality, the process modules 110 may perform each of the baking, coating, and developing processes for the substrate W.

The sensor unit 112 senses in real time an operation state, a process condition, and a process result, and the like of the process modules 110 at the time of process treating. The sensor unit 112 provides the sensed process parameter data to the process module controller 120. As an example, the sensor unit 112 may be connected to a computer or a computing module such as a user interface. Typically, the computing module processes analog data and converts raw analog data into data of a digital format. The computer module may transmit data to a data box through a network path and then to the process module controller 120. As an example, the process parameter may be pressure inside the process module 110. Unlike this, the process parameter may be a temperature inside the process module 110.

Alternatively, the process parameter may be various process conditions necessary for a treating process in the process module 110.

The process module controller 120 controls the sensor unit 112. The process module controller 120 receives data of the process parameter measured by the sensor unit 112. At this time, the process module controller 120 records a first time T1 which is a time when the data is received from the sensor unit 112. Then, the process module controller 120 transmit the received data to an equipment control unit 130. At this time, the process module controller 120 transmits information on the first time T1 to the equipment control unit 130.

The equipment control unit 130 receives data from the process module controller 120. The equipment control unit 130 may be prepared as, for example, a cluster tool controller (CTC). The equipment control unit 130 is connected to the process module controller 120 through a network (e.g., serial communication, LAN, and the like) and controls the overall operation of the substrate treating apparatus 100. The equipment control unit 130 may interwork with a plurality of process module controllers 120. The equipment control unit 130 transmits data to the processing unit 140. At this time, the equipment control unit 130 records a second time T2 which is a time when the data is transmitted to the processing unit 140. The equipment control unit 130 transmits information on the first and second times T1 and T2 to the processing unit 140.

The processing unit 140 receives data from the equipment control unit 130. The processing unit 140 processes the received data. As an example, the processing unit 140 may be provided with management software. The processing unit 140 may include a monitor unit 142. As an example, the monitor unit 142 may be provided to a fab host. A worker may check a treating process situation or a data processing through the monitor unit 142 and adjust a working situation. The processing unit 140 calculates latency using the first and second times T1 and T2.

Latency is a time elapsed from when data is created to when the data is processed and/or transmitted. In the present embodiment, the latency is a difference between a measurement time when the sensor unit 112 measures the process parameters and a check time when the worker can check through the monitor unit 142. At this point, the processing unit 140 may calculate the latency by using the difference between the second time T2 and the first time T1.

The processing unit 140 may calculate the latency by calculating an average value of the difference between the second time T2 and the first time T1. As an example, when the sensor unit 112 measures data of the process parameter plural number of times, the processing unit 140 may calculate the latency by calculating an average value with the time differences between the second time T2 and the first time T1, which are measured the plural number of times. Unlike this, when the sensor unit 112 measures the data of the process parameter for a first set time, the processing unit 140 may calculate the latency by calculating an average value with the time differences between the second time T2 and the first time T1 measured for the first set time. Unlike this, a condition or a period for calculating the average value may be differed according to a kind of a process or a sequence of the process.

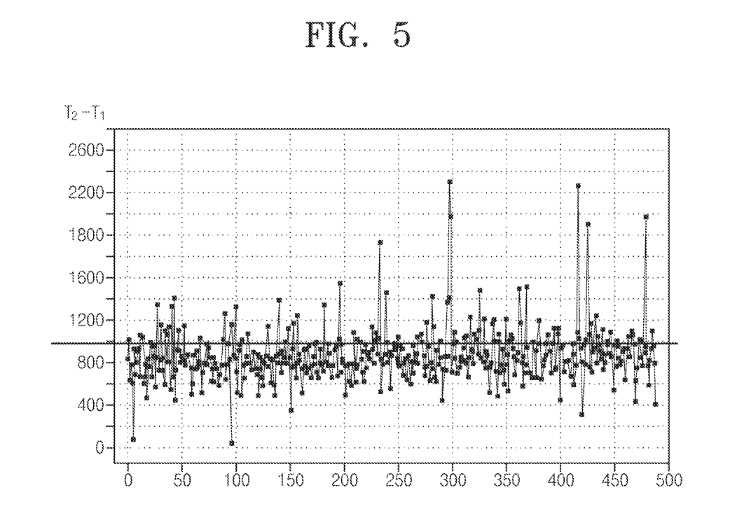

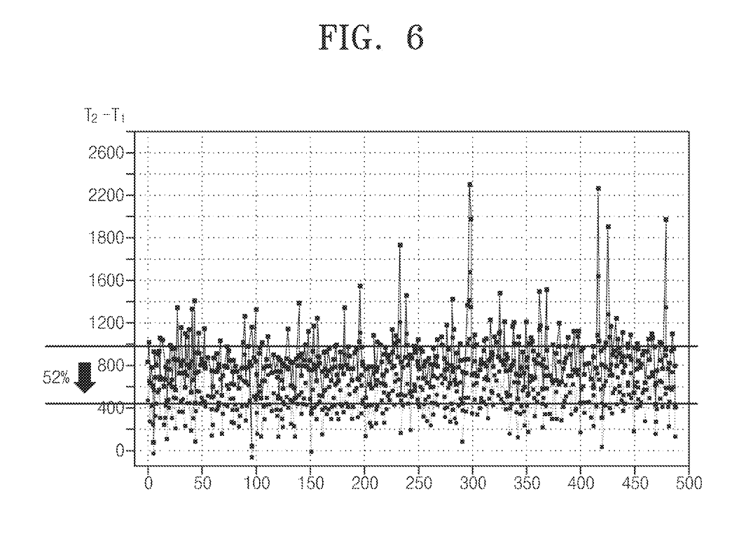

FIG. 5 is a view illustrating a difference (T2−T1) between the second time T2 and the first time T1 according to the number of times of data measurement. FIG. 6 is a view illustrating that a difference (T2−T1) between the second time T2 and the first time T1 is measured again after the substrate treating apparatus 100 is optimized. Referring FIG. 4, it may be seen that latency of 0.875 msec occurs by calculating the average value based on 500 measurements. Accordingly, after checking the latency, the worker may reduce the latency by optimizing devices of the substrate treating device 100. Through this, work efficiency may be maximized by precisely controlling the process parameter during treating the substrate W. As an example, the worker may reduce the latency by changing a polling scheme of the driver. Unlike this, the latency may be reduced by optimizing various facilities related to a data transmitting and receiving procedure.

Referring to FIG. 6, the worker optimizes the substrate treating apparatus 100 to reduce average latency to 0.421 msec. Accordingly, the latency may be reduced by about 52% compared to the existing one.

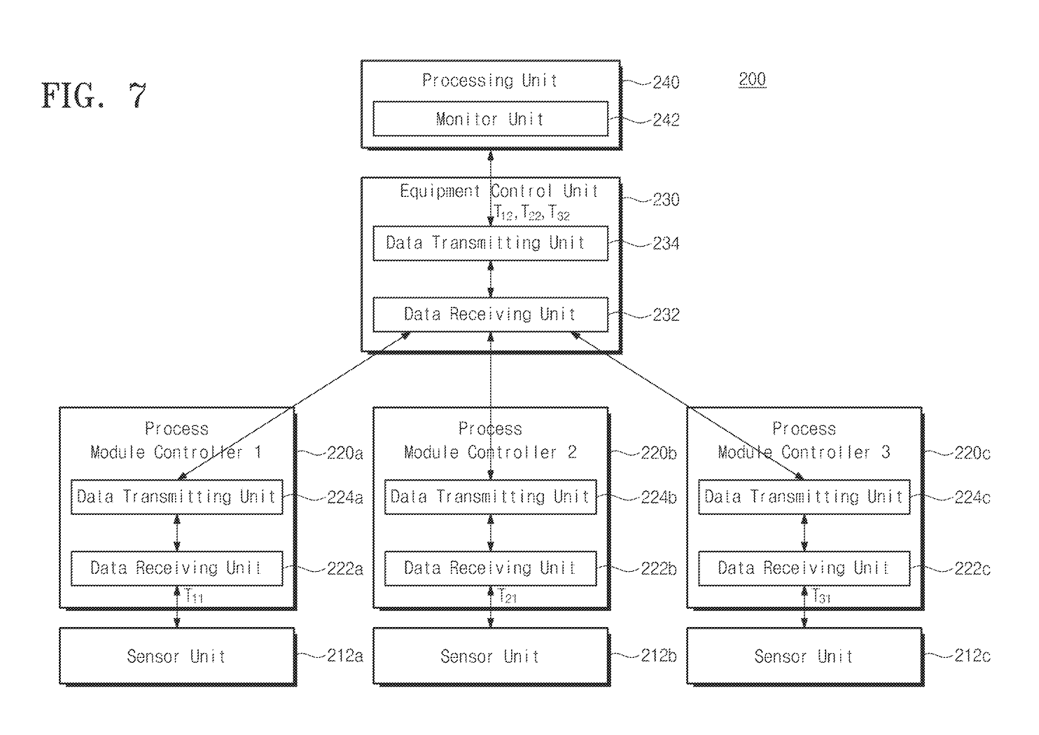

FIG. 7 illustrates a substrate treating apparatus 200 according to another embodiment. The substrate treating apparatus 200 includes a process module 210, a process module controller 220, an equipment control unit 230, and a processing unit 240. The equipment control unit 230 and the processing unit 240 in FIG. 6 have substantially identical or similar structures and functions to the equipment control unit 130 and the processing unit 140 of the substrate treating apparatus 100 in FIG. 2. However, the process module 210 and the process module controller 220 are provided in plurality. The equipment control unit 230 may interwork with a plurality of process module controllers 220a, 220b, and 220c. Accordingly, the equipment control unit 230 may process data measured by each of the sensor units 212a, 212b, and 212c and independently control working environments of the process modules 201a, 210b, and 210c.

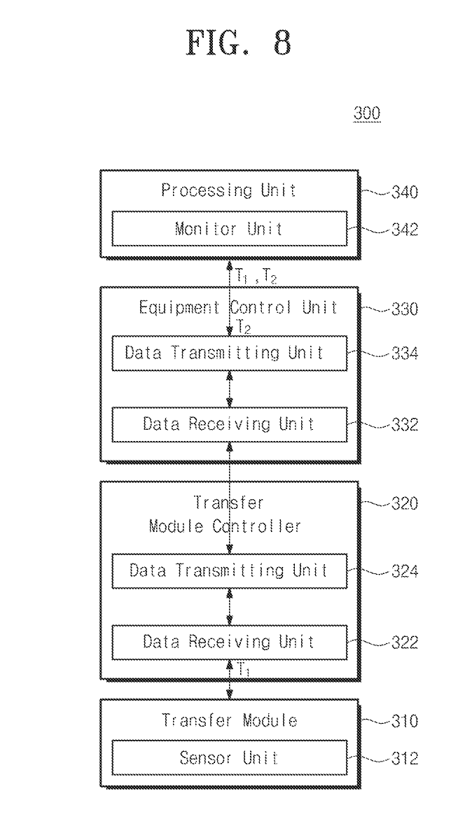

FIG. 8 illustrates a substrate treating apparatus 300 according to another embodiment. The substrate treating apparatus 300 includes a transfer module 310, a transfer module controller 320, an equipment control unit 330, and a processing unit 340. The equipment control unit 330 and the processing unit 340 in FIG. 7 have substantially identical or similar structures and functions to the equipment control unit 130 and the processing unit 140 of the substrate treating apparatus 100 in FIG. 2. However, the module and the module controller are provided in the transfer module 310 and the transfer module controller 320. The transfer module 310 may include a transfer device transferring the substrate W between process modules or between the process module and the transfer module 310. The transfer module controller 320 may measure a process parameter in the transfer module 310 and process data. Alternatively, the equipment control unit 330 may interwork with the plurality of transfer module controller 320.

The foregoing substrate treating method according to an embodiment of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

The substrate treating apparatus of the present embodiment has been described to sense and control pressure and temperature. Unlike this, the process parameters may be various kinds of process conditions necessary for a treating process in the module. As an example, the process parameter may be a flow rate of a process gas. In addition, the process parameter may be air clearness sensed by a fan filter unit. Alternatively, the substrate treating apparatus may include an alarm member and the like according to a measurement value of the process parameter. In addition, although described as interworking with the plurality of process module controllers or a plurality of transfer module controllers, the equipment control unit of the substrate treating apparatus of the present embodiment may alternatively control the process module controller and the transfer module controller together.

According to embodiments of the present invention, the present invention can provide a substrate treating apparatus capable of measuring latency.

The effects of the present invention are not limited to the above mentioned effects, and other effects not mentioned above may be clearly understood through the description and the accompanied drawings by those skilled in the art.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A substrate treating apparatus comprising:
a process module;
a sensor unit installed inside the process module and measuring a process parameter; and
a control unit controlling data of the process parameter measured by the sensor unit,
wherein the control unit comprises,
a module controller receiving the data measured by the sensing unit;
an equipment control unit receiving the data from the module controller; and
a processing unit receiving the data from the equipment control unit and processing the data,
wherein the processing unit calculates latency by using a first time, which is a time when the module controller receives the data from the sensor unit, and a second time, which is a time when the equipment control unit transmits the data to the processing unit.

2. The substrate treating apparatus of claim 1, wherein the processing unit calculates the latency by using a difference between the second and first times.

3. The substrate treating apparatus of claim 2, wherein the sensor unit measures the data of the process parameter plural number of times, and the processing unit calculates the latency by calculating an average value of a plurality of differences between the second and first times.

4. The substrate treating apparatus of claim 2, wherein the sensor unit measures the data of the process parameter for a first set time and the processing unit calculates the latency by calculating an average value of differences between the second and first times for the first set time.

5. The substrate treating apparatus of claim 3, wherein the module controller is a process module controller.

6. The substrate treating apparatus of claim 3, wherein the process module is a transfer module and process modules are disposed along a perimeter of the transfer module,
the sensor unit is a sensor unit installed inside the transfer module and measuring the process parameter, and the control unit comprises a controller controlling the data of the process parameter measured by the sensor unit, and
the module controller is a transfer module controller.

7. The substrate treating apparatus of claim 6, wherein the process parameter is pressure.

8. The substrate treating apparatus of claim 6, wherein the process parameter is a temperature.

9. The substrate treating apparatus of claim 6, wherein the module controller is provided in plurality.

10. The substrate treating apparatus of claim 6, wherein the processing unit further include a monitor unit displaying the data.

11. A substrate treating method in which a process parameter is measured by a sensor unit from a process module and latency is calculated by using data of the measured process parameter, wherein a processing unit calculates a first time, which is a time when a module controller receives the data from the sensor unit, and a second time, which is a time when the module controller transmits the data to an equipment control unit.

12. The substrate treating method of claim 11, wherein the processing unit calculates the latency by using a difference between the second and first times.

13. The substrate treating method of claim 12, wherein the sensor unit measures the data of the process parameter plural number of times, and the processing unit calculates the latency by calculating an average value of a plurality of differences between the second and first times.

14. The substrate treating method of claim 12, wherein the sensor unit measures the data of the process parameter for a first set time, and the processing unit calculates the latency by calculating an average value of differences between the second and first times for the first set time.

15. The substrate treating method of claim 13, wherein the module controller is provided in plurality.

16. The substrate treating method of claim 13, wherein the module controller is a transfer module controller.

17. The substrate treating method of claim 15, wherein the process parameter is pressure.

18. The substrate treating method of claim 15, wherein the process parameter is a temperature.

19. The substrate treating method of claim 15, wherein the module controller is provided in plurality.

20. A non-transitory computer readable medium having a program recorded thereon, which, when executed by a computer, performs the substrate treating method of claim 11.
